(19) United States
(12) Patent Application Publication
(10) Pub. No.: US 2024/0070456 A1
(43) Pub. Date: Feb. 29, 2024

(54) Corrective Reward Optimization for Sequential Labeling

(71) Applicant: Google LLC, Mountain View, CA (US)

(72) Inventors: Karthik Raman, Sunnyvale, CA (US); Kazuma Hashimoto, Menlo Park, CA (US)

(21) Appl. No.: 18/240,954

(22) Filed: Aug. 31, 2023

Related U.S. Application Data
(60) Provisional application No. 63/402,706, filed on Aug. 31, 2022.

(51) Int. Cl. G06N 3/08

(52) U.S. Cl. CPC G06N 3/08

(57) ABSTRACT

Provided are systems and methods for corrective reward optimization for generative sequential labeling. In particular, example aspects of the present disclosure are directed to an effective framework for generative reward optimization of text (or other) data sequences, certain example implementations of which can be referred to as “GROOT”. Example implementations of the proposed framework work by training a generative sequential labeling model to match the decoder output distribution with that of the (possibly black-box) reward function. Using an iterative training regime, the framework can first generate prediction candidates and then correct errors in the candidate. Finally, a loss function can be used that contrasts those candidates based on their reward values (e.g., as measured by a reward function that encodes the specific objectives for a particular setting or application).

### PRIORITY CLAIM

The present application is based on and claims priority to U.S. Provisional Application 63/402,706 having a filing date of Aug. 31, 2022, which is incorporated by reference herein in its entirety.

### FIELD

The present disclosure relates generally to machine learning. More particularly, the present disclosure relates to systems and methods for corrective reward optimization for generative sequential labeling.

### BACKGROUND

Sequential labeling tasks occur in many settings and domains, including in various natural language processing (NLP) applications. For example, tasks ranging from syntactic analysis (e.g., part of speech tagging and phrase chunking) to semantic analysis (e.g., named entity recognition, slot filling, and query segmentation), are important components in various end-to-end applications, such as search engines and goal-oriented dialog systems.

Advances in pretraining of generative language models (LMs) have enabled the use of common training strategies seamlessly across these diverse sequence labeling tasks. Specifically, one common approach is to finetune a pretrained LM by maximizing the likelihood of generating the ground-truth (human annotated) labeled data.

However, in practice, the metrics and constraints that may be important in various specific settings or applications are often fairly disconnected from common loss functions used during the training (e.g., finetuning) of LMs, such as the standard Negative Log-Likelihood (NLL) objective. For example, certain downstream applications of the LM may require a specific precision-recall balance and, therefore, precision errors (e.g., incorrectly annotated spans) can lead to catastrophic failures downstream.

Unfortunately, current approaches typically do not enable model developers to optimize for or incorporate such complex metrics or trade-offs into the model training process, but instead focus on a less complex objective, such as the NLL objective. The issue is further exacerbated when evaluating model predictions beyond the top-1 prediction—which will often demonstrate a drastic drop-off in quality.

Thus, while common supervised learning approaches have shown great success on various problems, there remains a significant disconnect between the training objectives of current models and the specific metrics and desiderata that may be important in certain practical applications. For example, a practical sequence tagging application may want to optimize for a certain precision-recall trade-off (e.g., of the top-k predictions) which is quite different from the standard objective of maximizing the likelihood of the ground truth labeled sequence.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform corrective reward optimization for sequential labeling. The method is performed for each of one or more training iterations. The method includes processing, by the computing system, a training input sequence with a machine-learned sequential labeling model to generate one or more candidate output sequences. The method includes applying, by the computing system, a correction function to at least a first candidate output sequence of the one or more candidate output sequences to generate a corrected output sequence. The method includes determining, by the computing system, a first reward value for the first candidate output sequence according to a reward function. The method includes determining, by the computing system, a second reward value for the corrected candidate output sequence according to the reward function. The method includes evaluating, by the computing system, a loss function that contrasts the first candidate output sequence with the corrected output sequence based on the first reward value and the second reward value. The method includes modifying, by the computing system, one or more parameter values of the machine-learned sequential labeling model based at least in part on the loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates a block diagram of an example framework for performing corrective reward optimization for sequential labeling according to example embodiments of the present disclosure.

FIG. 2 illustrates a block diagram of an example framework for performing corrective reward optimization for sequential labeling according to example embodiments of the present disclosure.

FIG. 3 illustrates a block diagram of an example use of a sequential labeling model according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods for corrective reward optimization for generative sequential labeling. In particular, example aspects of the present disclosure are directed to an effective framework for generative reward optimization of text (or other) data sequences, certain example implementations of which can be referred to as “GROOT”. Example implementations of the proposed framework work by training a generative sequential labeling model to match the decoder output distribution with that of the (possibly black-box) reward function. Using an iterative training regime, the framework can first generate prediction candidates and then correct errors in the candidate. Finally, a loss function can be used that contrasts those candidates based on their reward values (e.g., as measured by a reward function that encodes the specific objectives for a particular setting or application). As demonstrated via extensive experiments on four public benchmarks, GROOT significantly improves all reward metrics. Furthermore, GROOT also leads to improvements of the overall decoder distribution as evidenced by the quality gains of the top-k candidates.

Thus, one example aspect of the present disclosure is directed to an effective framework for training sequence labeling models to optimize (potentially black-box) reward metrics. Example implementations of the framework can take a generative sequential labeling approach to learn the reward metrics associated with the output space of sequences. Another example aspect is directed to a new Corrective Margin Loss (CIVIL) function. The proposed loss function can contrast candidates with differing reward metrics, thereby enabling the model to better explore and understand the reward space.

Example experiments demonstrate that simply relying on candidates sampled from the decoder output distribution—for example as proposed in prior work for machine translation—does not provide optimal results (and often worsens reward scores significantly). Instead, to enable principled and targeted exploration of the output reward space, example implementations of the present disclosure implement a correction function based approach—correcting errors in predictions to explore the space. Specifically, extensive experiments over 4 public datasets demonstrate that example implementations of the GROOT framework significantly improves rewards over existing works. Furthermore, GROOT learns a better overall decoder distribution with significant gains in correlation with reward scores observed across all benchmarks.

The systems and methods of the present disclosure provide a number of technical effects and benefits. As one example, the proposed techniques enable a model training process to more quickly and/or completely explore a reward space. The improved evaluation of a reward space may enable improved model performance on various tasks. Thus, the proposed techniques may improve the functionality of a computing system on various tasks including sequence labelling tasks. The improved evaluation of a reward space may also enable the ability to train a model to a performance point (e.g., convergence) more quickly. Training a model more quickly may enable a reduction in the consumption of computational resources such as reduced processor usage, reduced memory consumption, and reduced consumption of network bandwidth.

With reference now to the Figures, example embodiments of the present disclosure will be discussed in further detail.

### EXAMPLE MODEL TRAINING FRAMEWORK

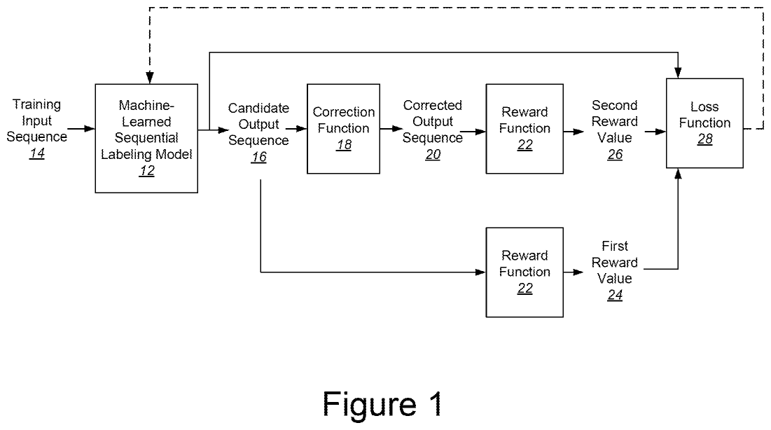

FIG. 1 depicts a block diagram of an example model training framework to perform corrective reward optimization for generative sequential labeling. As illustrated in FIG. 1, the framework can be applied to train a machine-learned sequential labeling model 12.

The machine-learned sequential labeling model 12 can be configured to receive an input sequence and process the input sequence to produce an output sequence. Thus, in some instances, the machine-learned sequential labeling model 12 may be referred to as or include a sequence to sequence model. As one example, the machine-learned sequential labeling model 12 can be or include an encoder model and a decoder model. As another example, the machine-learned sequential labeling model 12 can be or include a Transformer model or other self-attention based model.

The machine-learned sequential labeling model 12 can be configured to process input data of one or more different modalities, including text or other natural language data, audio data, image data, statistical data, sensor data, genomic data, and/or other modalities of data. The machine-learned sequential labeling model 12 can be configured to provide outputs having various output structures including sequential outputs having various output labels or other generative tasks.

Thus, as examples, the input sequence can be or include a sequence of natural language tokens and the machine-learned sequential labeling model 12 can generate an output sequence the includes: a translation of the sequence of natural language tokens; one or more part of speech classifications of the sequence of natural language tokens; one or more chunking classifications of the sequence of natural language tokens; one or more named entity recognitions for the sequence of natural language tokens; one or more segmentations for the sequence of natural language tokens; one or more named entity recognitions for the sequence of natural language tokens; one or more natural language answers to the sequence of natural language tokens; one or more dialog responses for the sequence of natural language tokens; and/or various other sequential outputs.

Referring still to FIG. 1, illustrated is a framework for corrective reward optimization for sequential labeling. The data flow shown in FIG. 1 may be repeated for a number of training iterations. Although a single example is shown, the illustrated data flow may be performed for a batch containing a larger number of examples. Specifically, a computing system can obtain a training input sequence 14. The computing system can process the training input sequence 14 with the machine-learned sequential labeling model 12 to generate one or more candidate output sequences. For example, the one or more candidate output sequences can include at least a first candidate output sequence 16.

The computing system can apply a correction function 18 to at least a first candidate output sequence 16 of the one or more candidate output sequences to generate a corrected output sequence 20. The computing system can determine a first reward value 24 for the first candidate output sequence 16 according to a reward function 22. The computing system can also determine a second reward value 26 for the corrected candidate output sequence according to the reward function 22.

The computing system can evaluate a loss function 28 that contrasts the first candidate output sequence 16 with the corrected output sequence 20 based on the first reward value 24 and the second reward value 26. The computing system can modify one or more parameter values of the machine-learned sequential labeling model 12 based at least in part on the loss function 28. For example, the loss function 28 can be backpropagated to update the parameter value(s) of the machine-learned sequential labeling model 12.

In some implementations, the correction function 18 can be or include a pre-defined function that, when applied to a function input, with positive probability relative to a training dataset, results in a function output that receives a larger reward value than the function input according to the reward function 22. Thus, for example, the second reward value 26 may be expected to be larger than the first reward value 24.

As examples in the context of a natural language input, the correction function 18 can one or both of: drop any predicted spans in the first candidate output sequence 16 that do not match with spans in a ground truth output sequence associated with the training input sequence 14; and replace one or more incorrect tags in the first candidate output sequence 16 with one or more ground truth tags included in the ground truth output sequence associated with the training input sequence 14.

In some implementations, the reward function 22 can be a pre-defined function that encodes various objectives associated with a deployment environment. In some examples, the reward function 22 may be a black box function. As an example, the reward function 22 can evaluate both precision and recall, thereby rewarding the model 12 for achieving a desired balance between precision and recall.

In some implementations, the loss function 28 can include a corrective margin loss term that contrasts the first candidate output sequence 16 with the corrected output sequence 20 based on the first reward value 24 and the second reward value 26. For example, the corrective margin loss term can provide a loss value that is equal to a maximum of zero or a margin loss value, the margin loss value equal to a margin value minus a log likelihood of the corrected output sequence 20 plus a log likelihood of the first candidate output sequence 16. For example, the margin value is equal to a scaling coefficient times a difference between the second reward value 26 and the first reward value 24. Thus, as one example, the corrective margin loss term may take the following form:

CML_{θ}(x; \tilde{y}; \tilde{r}; \tilde{y}₊\tilde{r}₊)=max (0; m−log p(\tilde{y}₊|x)+log p(\tilde{y}|x))

where x is the training input sequence 14; \tilde{y} is the first candidate output sequence 16; \tilde{r} is the first reward value 24; \tilde{y}₊; is the corrected output sequence 20; and \tilde{r}₊ is the second reward value 26, and where

m=α(\tilde{r}₊−\tilde{r})

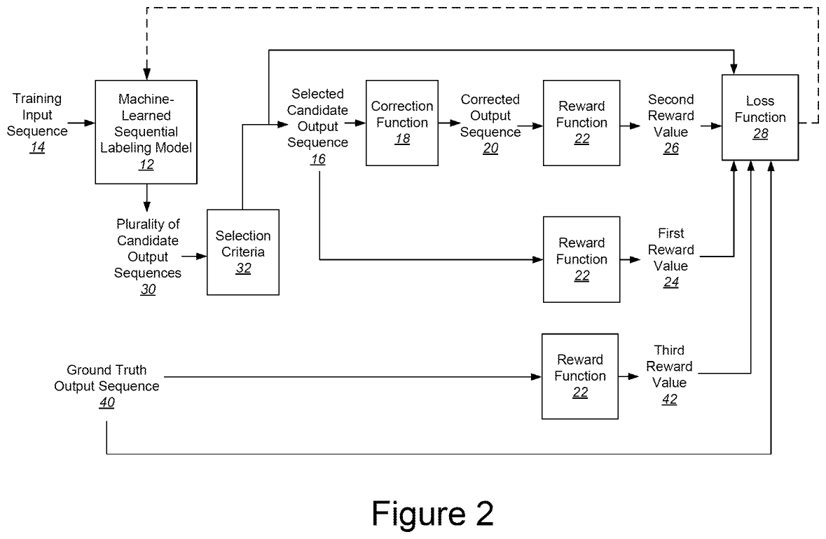

Referring now to FIG. 2, an additional example illustration of the proposed framework is provided. The proposed framework illustrated in FIG. 2 is similar to the framework shown in FIG. 1. However, FIG. 2 illustrates that, in some implementations, the computing system can process the training input sequence 14 with the machine-learned sequential labeling model 12 to generate a plurality of candidate output sequences 30. The computing system can select the first candidate output sequence 16 from the plurality of candidate output sequences 30 according to one or more criteria 32.

As one example, processing, by the computing system, the training input sequence 14 with the machine-learned sequential labeling model 12 to generate the plurality of candidate output sequences can include performing a beam search over an output space of the machine-learned sequential labeling model 12 to generate the plurality of candidate output sequences 30 (e.g., to generate the top-k outputs).

As another example, selecting, by the computing system, the first candidate output sequence 16 from the plurality of candidate output sequences 30 according to the one or more criteria 32 can include: determining, according to the reward function 22, a respective reward value for each of the plurality of candidate output sequences 30; and selecting as the first candidate output sequence 16 the candidate output sequence that receives the largest respective reward value. As another example, the candidate output sequence that receives the smallest respective reward value can be selected. As yet another example, one of the plurality of candidate output sequences 30 can be randomly selected as the selected candidate output sequence 16.

According to another aspect, as shown in FIG. 2, the loss function 28 can also receive as inputs a ground truth output sequence 40 and/or a third reward value 42 generated for the ground truth output sequence 40 according to the reward function 22. Specifically, in some implementations, the loss function 28 can also include an additional corrective loss term that contrasts the corrected output sequence 20 with the ground truth output sequence 40 based on the second reward value 26 and the third reward value 42. For example, the additional corrective loss term can be expressed as CML_{θ}(x; \tilde{y}₃₀; \tilde{r}₊; y*; r*), where y* is the ground truth output sequence 40 and r* is the third reward value 42. Additionally or alternatively, the loss function 28 can include an NLL loss term.

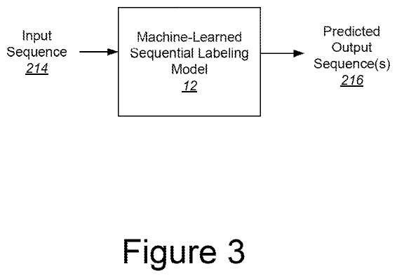

FIG. 3 illustrates a block diagram of an example use of a sequential labeling model 12 according to example embodiments of the present disclosure. For example, the model 12 shown in FIG. 3 can have been trained as shown in FIG. 1 and/or FIG. 2. At inference time, the trained model 12 can receive an input sequence 214. The model 12 can process the input sequence 214 to generate one or more predicted output sequences 216.

### Example Implementations

This section describes example implementations of the systems and methods describes herein. Solely optimizing the NLL loss may not provide sufficient exploration of the output metric space. Given a predefined (blackbox) reward function, some example implementations configure the Seq2Seq model to learn an output distribution that more closely correlates with and maximizes reward values.

To tackle this issue, the present disclsoure proposes a framework that works by iteratively training and improving the reward of decoder outputs. More specifically, starting from the NLL-based initial model θ⁽¹⁾, in each iteration 2≤t≤T some example implementations:

First, create a new training set [symbol] ₜ by correcting (top-k) predictions (on a subset of the training set) of the previous model θ^{(t-1}) . Leveraging this correction function is key to efficiently explore the output space and significantly outperforms exploration based solely on current predictions.

Second, train a new improved model θ^{(t)} using [symbol] ₜ by applying the proposed Corrective Margin Loss that contrasts and orders different candidates based on their rewards.

Henceforth this description will denote the predefined (blackbox) reward as R, where R(y, y*) denotes the reward for an example prediction y (optionally computed using the gold label y*).

### Example Data Generation

For the t-th step of the proposed framework, some example implementations create a new training set [symbol] ₜ from a (random) subset of the training data [symbol] ′ₜ. In particular, for each example e=(x,y*) ∈ [symbol] ′ₜ, some example implementations do the following:

Get top-k predictions: Using the previous timestep's model θ^{(t-1}), some example implementations perform inference on [symbol] ′ₜ using a beam search to generate the top-k output candidates for each example e.

Select correctable candidate: Using the input reward function R(y, y*) some example implementations compute a reward value for each of the top-k candidates y. Based on the rewards some example implementations select \tilde{y}, using a fixed criterion (e.g. a non-perfect candidate with highest reward in top-k). To maximize learning of the output- reward relation, some example implementations only select candidates that can be “corrected”—as described below.

One might assume that simply comparing the top-k allows for sufficient learning of the output space. However, as some example implementations show empirically (in Section ??), simply using the top-k predictions alone is unreliable and does not allow for sufficient exploration of the output space—and at times may even worsen results (Table ??). Thus to help us better explore the output space in a guided manner, some example implementations introduce a key additional step:

Correct erroneous candidate: To effectively learn what predictions lead to better reward values, some example implementations introduce correction functions to rectify erroneous predictions. More specifically, a correction function C(y, y*) is designed to return a new prediction y₊, such that r₊=R(y₊,y*) is expected be greater than (or equal to) r=R(y,y*).

In other words, given an imperfect prediction y—and optionally the gold label y*—the correction function aims to find a prediction that improves upon or fixes errors in y. The goal of the correction function is not to find the best possible prediction y₊(which would just be the gold label y*) but rather to expose the model to novel (improved) prediction candidates—potentially quite different from the existing model's output distribution. Since correction functions will be used to improve predictions and explore the output space, they could be either algorithmic or themselves model-based. Note that in some applications with complex reward function, some example implementations may not be able to easily devise a single correction function that always finds an improved prediction. However in such cases, some example implementations can instead combine multiple correction functions. some example implementations require that the functions together can produce a y₊(s.t., r₊≥r) with high probability. If some example implementations cannot find an improved y₊from any correction functions, then some example implementations can choose to drop the example instead.

Given this improved y₊, each example e can be expanded to form a new tuple: \tilde{e}=(x, y*, r*, \tilde{y}, \tilde{r}, \tilde{y}₊, \tilde{r}₊), where r*=R(y*, y*), \tilde{r}=R(\tilde{y}, y*), and \tilde{r}₊=R(\tilde{y}₊, y*).

### Example Training with Corrective Margin Loss

To help the model best learn the output space of rewards some example implementations train the model by contrasting pairs of \tilde{y} and \tilde{y}₊. In particular, for each \tilde{e} ∈ [symbol] ₜ some example implementations use the following corrective margin loss:

CML_{θ}(x, \tilde{y}, \tilde{r}, \tilde{y}₊, \tilde{r}₊)=max (0; m−logp(\tilde{y}₊|x)+logp(\tilde{y}|x)) (1)

where m is a margin computed with a hyperparameter α: m=α(\tilde{r}₊−\tilde{r}).

Some example implementations use CML to teach the model learn to prefer the corrected \tilde{y}₊over the original \tilde{y}.

While the above formulation of CML does not directly use the gold label y*, some example implementations can incorporate y* by also teaching the model to explicitly prefer y* over \tilde{y}₊—since some example implementations would still like the model to ideally produce y* as the best candidate. Thus some example implementations add another CML term to define the following corrective ranking loss:

CRL_{θ}(e′)=CML_{θ}(x, \tilde{y}, \tilde{r}, \tilde{y}₊, \tilde{r}₊)+CML₇₄ (x, \tilde{y}₊, \tilde{r}₊, y*, r* (2)

To further prioritize the gold label some example implementations can still include NLL in the training loss as:

λ×NLL_{θ}(e)+(1.0−λ)×CRL_{θ}(e′) (3)

where λ∈[0,1.0] is a hyperparameter to control the regularization effect by NLL_{θ}(e). In practice some example implementations found that a small value of λ helped stabilize learning and reduce variance.

### Example Reward Functions

Practical applications for a generative model may span a variety of different complex reward functions which some example implementations would like to optimize for directly. Unfortunately public benchmarks do not come up with any such provided complex reward function. Thus some example implementations look to create a realistic reward function—for the running example of a sequence tagger/entity recognizer. The reward function should be realistic enough to reflect the complexities of real-world metrics (and thus more complex than what traditional techniques can optimize) while still being understandable for us and readers.

As motivated in the introduction, practical applications may weight precision and recall differently. With β controlling the importance of precision vs. recall, consider a reward of the form:

R(y, y*)=β×precision(y, y*)+recall(y, y*), (4)

To further challenge the model, the definition of precision for sequence labeling can be evaluated—which highlights a practical issue that needs addressing. Consider this synthetic example:

Ground truth: y*=[A X] Y Z [B W U] [C V]

Prediction (1): y₁=[D X] Y [E Z W U] [F V] (a completely imprecise prediction)

Prediction (2): y₂=X Y Z W U V (an empty prediction)

The typical definition of precision would lead to precision(y₁, y*)=precision(y₂, y*)=0, since the number of true positives is 0. However in practice these two predictions would have very different behaviors. When used to influence search engine behavior the first prediction would lead to far worse results (due to false positives) unlike the second prediction. This boils down to the precision metric not differentiating between false positives and empty predictions—which is a valid choice in sequential tagging problems. To more closely reflect this distinction, modify the definition of the span-level precision to be:

$${precision}^{′} ( y , {y}^{*} ) = \frac{TP - c \times FP}{TP + FP} , \qquad ( 5 )$$

where TP and FP stand for true positive and false positive, respectively, and c (≥0) is a hyperparameter to explicitly penalize false positives.

When c=0 some example implementations recover the classical precision metric. This small change now allows us to easily distinguish the above two predictions y₁ and y₂:

$${precision}^{′} ( {y}_{1} , {y}^{*} ) = \frac{0 - c \times 3}{0 + 3} = - c < {precision}^{′} ( {y}_{2} , {y}^{*} ) = 0. \qquad ( 6 )$$

As an illustrative reward, some example implementations set (c, β)=(2,4) for the reward function in the rest of the paper—leading to reward scores between −8 (completely wrong) to +5 (perfect).

The above is just one example of a complex but realistic reward function. Other reward functions can be used as well.

### Example Correction Functions

The goal of the correction function is to help explore the output space by yielding improved predictions y₊=C(y, y*) such that R(y₊,y*)≥R(y,y*) w.h.p. While the suitability of a correction function may depend on the desired reward function, this section defines three correction operations that some example implementations found widely effective across a slew of sequential tagging reward functions: Drop, Replace and Annotate.

Drop: Is designed to fix precision errors by dropping tagged spans in the predictiony that do not match with the ground truthy*. In addition to improving precision, this also often enables exploring new candidates—since NLL training does not explicitly teach the model to drop uncertain tags. For the example y₁ in Section 2.1, this would result in all predicted spans being dropped.

Replace: Works by replacing incorrect tags iny with the correct ground-truth tags. For y₁ this would result in fixing “[D X]” and “[F V]” to produce “[A X] Y [E Z W U] [C V]”.

Annotate: Improves recall by annotating untagged spans with the correct ground-truth tags.

Some example implementations can also combine these operations. For example combining all three can lead to perfectly fixing any predictions. Given the example reward's focus on precision, some example implementations combine the first two (which improve precision) to give us the proposed correction function (see Algorithm 1). This function not only fixes most possible errors in predictions, but also helps efficiently explore the output space.

Algorithm 1: Correction Function:

| | |
|---|---|
| 1: | function C(y, y*) |
| 2: | y_{R} = REPLACE(y, y*) |
| 3: | y_{D} = DROP(y_{R}, y*) |
| 4: | if y_{D} == y* then |
| 5: | y₊ = DROP(y, y*) |
| 6: | else |
| 7: | y₊ = y_{D} |
| 8: | end if |
| 9: | return y₊ |
| 10: | end function |

### Example Devices and Systems

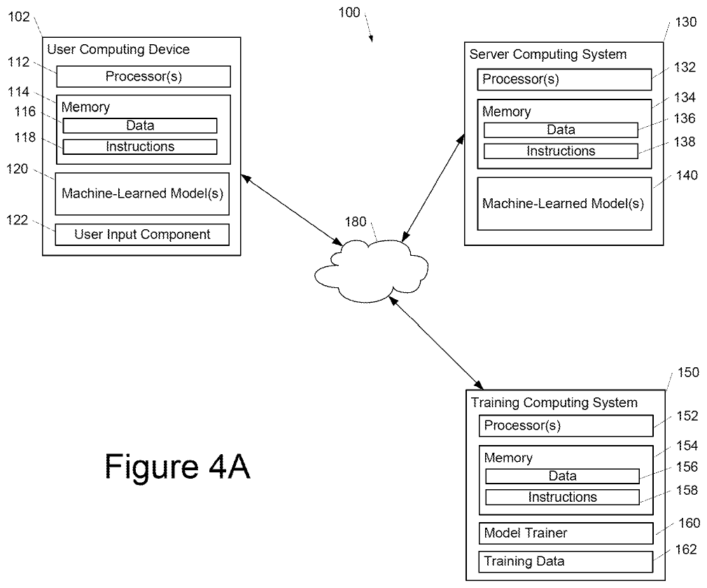

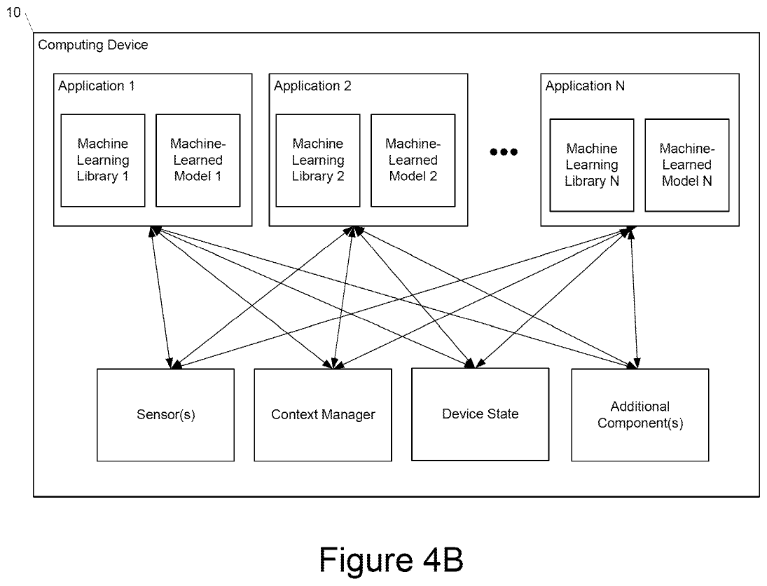

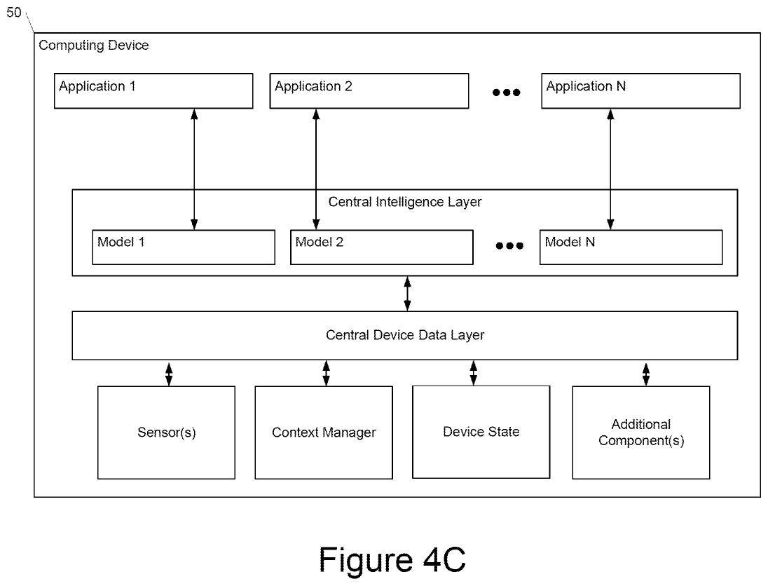

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1 and 2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel sequential processing across multiple instances of input sequences).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1 and 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform corrective reward optimization for sequential labeling, the method comprising:
for each of one or more training iterations:
processing, by the computing system, a training input sequence with a machine-learned sequential labeling model to generate one or more candidate output sequences;
applying, by the computing system, a correction function to at least a first candidate output sequence of the one or more candidate output sequences to generate a corrected output sequence;
determining, by the computing system, a first reward value for the first candidate output sequence according to a reward function;
determining, by the computing system, a second reward value for the corrected candidate output sequence according to the reward function;
evaluating, by the computing system, a loss function that contrasts the first candidate output sequence with the corrected output sequence based on the first reward value and the second reward value; and
modifying, by the computing system, one or more parameter values of the machine-learned sequential labeling model based at least in part on the loss function.

2. The computer-implemented method of claim 1, wherein:
processing, by the computing system, the training input sequence with the machine-learned sequential labeling model to generate the one or more candidate output sequences comprises processing, by the computing system, the training input sequence with the machine-learned sequential labeling model to generate a plurality of candidate output sequences; and
the method further comprises selecting, by the computing system, the first candidate output sequence from the plurality of candidate output sequences according to one or more criteria.

3. The computer-implemented method of claim 2, wherein processing, by the computing system, the training input sequence with the machine-learned sequential labeling model to generate the plurality of candidate output sequences comprises performing a beam search over an output space of the machine-learned sequential labeling model to generate the plurality of candidate output sequences.

4. The computer-implemented method of claim 2, wherein selecting, by the computing system, the first candidate output sequence from the plurality of candidate output sequences according to the one or more criteria comprises:
determining, according to the reward function, a respective reward value for each of the plurality of candidate output sequences; and
selecting as the first candidate output sequence the candidate output sequence that receives the largest respective reward value.

5. The computer-implemented method of claim 1, wherein the correction function comprises a pre-defined function that, when applied to a function input, with positive probability relative to a training dataset, results in a function output that receives a larger reward value than the function input according to the reward function.

6. The computer-implemented method of claim 1, wherein the correction function one or both of:
drops any predicted spans in the first candidate output sequence that do not match with spans in a ground truth output sequence associated with the training input sequence; and
replaces one or more incorrect tags in the first candidate output sequence with one or more ground truth tags included in the ground truth output sequence associated with the training input sequence.

7. The computer-implemented method of claim 1, wherein the reward function evaluates both precision and recall.

8. The computer-implemented method of claim 1, wherein the loss function comprises a corrective margin loss term that contrasts the first candidate output sequence with the corrected output sequence based on the first reward value and the second reward value, wherein the corrective margin loss term provides a loss value that is equal to a maximum of zero or a margin loss value, the margin loss value equal to a margin value minus a log likelihood of the corrected output sequence plus a log likelihood of the first candidate output sequence.

9. The computer-implemented method of claim 8, wherein the margin value is equal to a scaling coefficient times a difference between the second reward value and the first reward value.

10. The computer-implemented method of claim 1, further comprising:
determining, by the computing system, a third reward value for a ground truth output sequence according to the reward function;
wherein loss function further contrasts the corrected output sequence with the ground truth output sequence based on the second reward value and the third reward value.

11. The computer-implemented method of claim 1, wherein:
the training input sequence comprises a sequence of natural language tokens; and
the first candidate output sequence comprises:
a translation of the sequence of natural language tokens;
one or more part of speech classifications of the sequence of natural language tokens;
one or more chunking classifications of the sequence of natural language tokens;
one or more named entity recognitions for the sequence of natural language tokens;
one or more segmentations for the sequence of natural language tokens;
one or more named entity recognitions for the sequence of natural language tokens;
one or more natural language answers to the sequence of natural language tokens; or
one or more dialog responses for the sequence of natural language tokens.

12. A computing system configured to perform corrective reward optimization for sequential labeling, the computing system comprising one or more processors and one or more non-transitory computer-readable storing instructions that when executed by the one or more processors cause the computing system to perform operations, the operations comprising:
for each of one or more training iterations:
processing, by the computing system, a training input sequence with a machine-learned sequential labeling model to generate one or more candidate output sequences;
applying, by the computing system, a correction function to at least a first candidate output sequence of the one or more candidate output sequences to generate a corrected output sequence;
determining, by the computing system, a first reward value for the first candidate output sequence according to a reward function;
determining, by the computing system, a second reward value for the corrected candidate output sequence according to the reward function;
evaluating, by the computing system, a loss function that contrasts the first candidate output sequence with the corrected output sequence based on the first reward value and the second reward value; and
modifying, by the computing system, one or more parameter values of the machine-learned sequential labeling model based at least in part on the loss function.

13. The computing system of claim 12, wherein:
processing, by the computing system, the training input sequence with the machine-learned sequential labeling model to generate the one or more candidate output sequences comprises processing, by the computing system, the training input sequence with the machine-learned sequential labeling model to generate a plurality of candidate output sequences; and
the operations further comprise selecting, by the computing system, the first candidate output sequence from the plurality of candidate output sequences according to one or more criteria.

14. The computing system of claim 13, wherein processing, by the computing system, the training input sequence with the machine-learned sequential labeling model to generate the plurality of candidate output sequences comprises performing a beam search over an output space of the machine-learned sequential labeling model to generate the plurality of candidate output sequences.

15. The computing system of claim 13, wherein selecting, by the computing system, the first candidate output sequence from the plurality of candidate output sequences according to the one or more criteria comprises:
determining, according to the reward function, a respective reward value for each of the plurality of candidate output sequences; and
selecting as the first candidate output sequence the candidate output sequence that receives the largest respective reward value.

16. The computing system of claim 12, wherein the correction function comprises a pre-defined function that, when applied to a function input, with positive probability relative to a training dataset, results in a function output that receives a larger reward value than the function input according to the reward function.

17. The computing system of claim 12, wherein the correction function one or both of:
drops any predicted spans in the first candidate output sequence that do not match with spans in a ground truth output sequence associated with the training input sequence; and
replaces one or more incorrect tags in the first candidate output sequence with one or more ground truth tags included in the ground truth output sequence associated with the training input sequence.

18. The computing system of claim 12, wherein the reward function evaluates both precision and recall.

19. The computing system of claim 12, wherein the loss function comprises a corrective margin loss term that contrasts the first candidate output sequence with the corrected output sequence based on the first reward value and the second reward value, wherein the corrective margin loss term provides a loss value that is equal to a maximum of zero or a margin loss value, the margin loss value equal to a margin value minus a log likelihood of the corrected output sequence plus a log likelihood of the first candidate output sequence.

20. One or more non-transitory computer readable media that store computer-executable instructions for performing operations, the operations comprising, for each of one or more training iterations:
processing a training input sequence with a machine-learned sequential labeling model to generate one or more candidate output sequences;
applying a correction function to at least a first candidate output sequence of the one or more candidate output sequences to generate a corrected output sequence;
determining a first reward value for the first candidate output sequence according to a reward function;
determining a second reward value for the corrected candidate output sequence according to the reward function;
evaluating a loss function that contrasts the first candidate output sequence with the corrected output sequence based on the first reward value and the second reward value; and
modifying one or more parameter values of the machine-learned sequential labeling model based at least in part on the loss function.
